(19) United States
(12) Patent Application Publication
(10) Pub. No.: US 2019/0375215 A1
(43) Pub. Date: Dec. 12, 2019

(54) ACTIVE ENERGY RAY IRRADIATION APPARATUS AND INKJET PRINTER

(71) Applicant: Konica Minolta, Inc., Tokyo (JP)

(72) Inventors: Junichiro TAKAHASHI, Tokyo (JP); Shota OKUDA, Sagamihara-shi (JP)

(21) Appl. No.: 16/410,203

(22) Filed: May 13, 2019

(30) Foreign Application Priority Data
Jun. 7, 2018 (JP) 2018-109812

(51) Int. Cl. B41J 11/00

(52) U.S. Cl. CPC B41J 11/002

(57) ABSTRACT

An active energy ray irradiation apparatus includes: an irradiator into which a recording medium having a surface to which a radically curable ink to be cured by an active energy ray is attached is carried in a direction along the surface and which irradiates the radically curable ink with an active energy ray; and a blower that blows an airflow onto the surface of the recording medium before being carried into the irradiator, wherein the airflow has a flow rate component in a direction perpendicular to a carry-in direction of the recording medium, equal to or more than 1.5 times a carry-in speed of the recording medium, on the surface of the recording medium.

The entire disclosure of Japanese patent Application No. 2018-109812, filed on Jun. 7, 2018, is incorporated herein by reference in its entirety.

### BACKGROUND

### Technological Field

The present invention relates to an active energy ray irradiation apparatus, specifically to an active energy ray irradiation apparatus and an inkjet printer, capable of destroying a laminar flow (air layer) formed near a surface of a recording medium by an airflow blown onto the surface of the recording medium.

### Description of the Related Art

A radically curable ink (for example, radical UV ink) used in an inkjet printer has high reactivity with oxygen and has a characteristic that a polymerization reaction is inhibited by oxygen in the atmosphere during curing by irradiation with an active energy ray (oxygen inhibition).

For example, in printing on a food package, an ink requires high safety. Therefore, formulation of the ink is limited, and there is no choice but to use an ink susceptible to oxygen inhibition.

In order to solve this problem, there is known a method for supplying a gas inert to a radically curable ink, such as nitrogen (N₂), at the time of curing, and replacing air containing oxygen near a surface of a recording medium with the inert gas (JP 2017-064985 A, JP 2008-221651 A, and JP 2005-081277 A).

By the way, even if an inert gas is supplied near a surface of a recording medium, air is not replaced with the inert gas disadvantageously due to a laminar flow (air layer) formed near the surface of the recording medium. If air is not sufficiently replaced with the inert gas, oxygen remains on a surface of a radically curable ink at the time of curing by irradiation with an active energy ray, and the radically curable ink may be susceptible to oxygen inhibition.

In order to sufficiently replace air with the inert gas, the laminar flow formed near the surface of the recording medium needs to be destroyed.

JP 2017-064985 A has studied an angle of an airflow of an inert gas but does not describe a flow rate. JP 2008-221651 A describes that a flow rate of an inert gas is made equal to a carry-in speed of a recording medium. However, J P 2008-221651 A has not studied an angle of an airflow. JP 2005-081277 A has not studied an angle of an airflow of an inert gas and a flow rate thereof. An airflow of an inert gas described in each of JP 2017-064985 A, JP 2008-221651 A, and JP 2005-081277 A cannot destroy a laminar flow near a surface of a recording medium.

### SUMMARY

Therefore, an object of the present invention is to provide an active energy ray irradiation apparatus and an inkjet printer, capable of destroying a laminar flow (air layer) formed near a surface of a recording medium by an airflow blown onto the surface of the recording medium.

Furthermore, other objects of the present invention will become apparent from the following description.

To achieve at least one of the abovementioned objects, according to an aspect of the present invention, an active energy ray irradiation apparatus reflecting one aspect of the present invention comprises: an irradiator into which a recording medium having a surface to which a radically curable ink to be cured by an active energy ray is attached is carried in a direction along the surface and which irradiates the radically curable ink with an active energy ray; and a blower that blows an airflow onto the surface of the recording medium before being carried into the irradiator, wherein the airflow has a flow rate component in a direction perpendicular to a carry-in direction of the recording medium, equal to or more than 1.5 times a carry-in speed of the recording medium, on the surface of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic side view illustrating an inkjet printer according to an embodiment of the present invention;

FIG. 2 is a schematic side view illustrating an active energy ray irradiation apparatus according to an embodiment of the present invention;

FIG. 3 is a schematic side view illustrating a mode (45°) of the active energy ray irradiation apparatus having a different airflow direction;

FIG. 4 is a schematic side view illustrating a main part of the active energy ray irradiation apparatus illustrated in FIG. 3;

FIG. 5 is a schematic side view illustrating a mode (135°) of the active energy ray irradiation apparatus having a different airflow direction;

FIG. 6 is a schematic side view illustrating a main part of the active energy ray irradiation apparatus illustrated in FIG. 5;

FIG. 7 is a graph illustrating a minimum condition (1) for destroying a laminar flow in the active energy ray irradiation apparatus;

FIG. 8 is a graph illustrating a minimum condition (2) for destroying a laminar flow in the active energy ray irradiation apparatus;

FIG. 9 is a graph illustrating a relationship between a flow rate of an inert gas and a carry-in speed of a recording medium in the active energy ray irradiation apparatus;

FIG. 10 is a graph illustrating a relationship between a ratio (r) of a minimum flow rate of an inert gas and a carry-in speed, and destruction of a laminar flow in the active energy ray irradiation apparatus;

FIG. 11 is a graph illustrating an oxygen concentration when a laminar flow is destroyed in an irradiator of the active energy ray irradiation apparatus; and

FIG. 12 is a schematic side view illustrating an active energy ray irradiation apparatus according to another embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

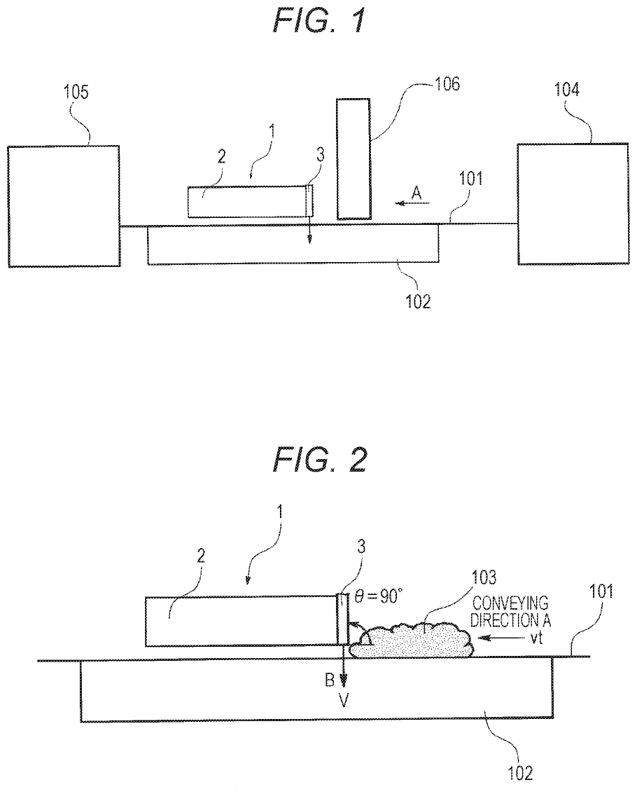

FIG. 1 is a schematic side view illustrating an inkjet printer according to an embodiment of the present invention.

According to this embodiment, as illustrated in FIG. 1, the inkjet printer irradiates a radically curable ink attached to a surface (upper side in FIG. 1) of a recording medium 101 with an active energy ray to cure the radically curable ink.

This inkjet printer includes a conveyer 102 for conveying the recording medium 101. The conveyer 102 conveys the recording medium 101 in a direction along a surface while having the recording medium 101 thereon and maintaining flatness, causes a recording head 106 to form an image with a radically curable ink on the recording medium 101, and then carries the recording medium 101 into an active energy ray irradiation apparatus 1. The recording medium 101 is formed of various kinds of paper, cloth, a synthetic resin sheet, a metal foil, or the like, and an image is formed on a surface (upper side in FIG. 1) thereof by the recording head 106.

The recording medium 101 may be either an elongated (roll-shaped) sheet or a single wafer type sheet. The recording medium 101 is stored in a supply stocker 104. The conveyer 102 includes a conveying belt for conveying the recording medium 101. The conveying belt is an endless belt formed of a flexible material such as rubber or synthetic resin. The conveying belt is moved and operated while having the recording medium 101 supplied from the supply stocker 104 thereon, and thereby conveys the recording medium 101 as indicated by arrow A in FIG. 1. A conveying speed of the recording medium 101 is not particularly limited.

The conveyer 102 conveys the recording medium 101, causes the recording medium 101 to pass through an image forming area capable of forming an image by the recording head 106, and carries the recording medium 101 into the active energy ray irradiation apparatus 1. Furthermore, the conveyer 102 conveys the recording medium 101 that has passed through the active energy ray irradiation apparatus 1 and discharges the recording medium 101 to a discharge stocker 105.

In this embodiment, the recording head 106 is an inkjet recording head to be fixedly disposed during image formation, and constitutes a so-called single pass type inkjet printer. However, the present invention can also be applied to a so-called scan type inkjet printer.

The recording head 106 includes, for example, eight monochrome heads for eight colors in total, including a yellow recording head for a yellow ink, a magenta recording head for a magenta ink, a cyan recording head for a cyan ink, and a black recording head for a black ink. However, the present invention is not limited thereto, and the number of monochrome heads can be increased or decreased appropriately.

Note that the inkjet printer according to an embodiment of the present invention is not limited to a configuration in which the inkjet printer conveys the recording medium 101 while maintaining flatness by a conveying belt. The inkjet printer may convey the recording medium 101 as a cylindrical shape by a conveying drum. Incidentally, in the configuration in which the recording medium 101 is conveyed by the conveying drum, a direction along a surface of the recording medium 101 refers to a tangential direction of a surface of the conveying drum, and an “airflow angle θ” described later refers to an angle with respect to a tangent to the surface of the conveying drum.

The radically curable ink is an ink (ink composition) to be cured by a radical polymerization reaction caused by irradiation with an active energy ray. The “active energy ray” is an energy ray capable of imparting energy to generate an initiating species in an ink composition by irradiation therewith, and examples thereof include an a ray, a y ray, an X ray, an ultraviolet ray (UV), and an electron ray. Among these rays, the ultraviolet ray and the electron ray are preferable, and the ultraviolet ray is more preferable from viewpoints of curing sensitivity and availability of an apparatus.

By irradiation with an active energy ray, a radically polymerizable compound contained in the radically curable ink is polymerized, and the radically curable ink is cured. The radically polymerizable compound may be a monomer, a polymerizable oligomer, a prepolymer, or a mixture thereof.

The radically polymerizable compound is not particularly limited, and examples thereof include an N-vinyl compound (compound having N—C═C structure) and an unsaturated carboxylate. Examples of the N-vinyl compound include N-vinylcaprolactam, N-vinylpyrrolidone, and N-vinylformamide. Examples of the unsaturated carboxylate include (meth)acrylate. These compounds may be used singly or in combination of a plurality of kinds thereof.

The content of the radically polymerizable compound is preferably, for example, in a range of 1 to 97% by mass with respect to the total mass of the ink from a viewpoint of curability or the like, and more preferably in a range of 30 to 95% by mass.

The radically curable ink can contain a photo radical initiator. Examples of the photo radical initiator include a cleavage type radical initiator and a hydrogen abstraction type radical initiator. Examples of the cleavage type radical initiator include an acetophenone-based initiator, a benzoin-based initiator, an acylphosphine oxide-based initiator, benzyl, and a methylphenylglyoxy ester. Examples of the hydrogen abstraction type radical initiator include a benzophenone-based initiator, a thioxanthone-based initiator, an aminobenzophenone-based initiator, 10-butyl-2-chloroacridone, 2-ethylanthraquinone, 9,10-phenanthrene quinone, and camphor quinone.

The content of the photo radical initiator only needs to be in a range in which the ink can be sufficiently cured, and can be, for example, in a range of 0.01 to 10% by mass with respect to the total mass of the ink.

The radically curable ink may contain a component other than the above-described components. Examples of other component include a coloring material such as a pigment or a dye, a gelling agent, a polymerization inhibitor, and a surfactant.

FIG. 2 is a schematic side view illustrating an active energy ray irradiation apparatus according to an embodiment of the present invention.

In the active energy ray irradiation apparatus 1, as illustrated in FIG. 2, the recording medium 101 having a surface to which a radically curable ink is attached is carried in a direction along the surface. The active energy ray irradiation apparatus 1 includes an irradiator 2 for irradiating a radically curable ink with an active energy ray. The irradiator 2 includes, for example, an ultraviolet light source (ultraviolet lamp) (not illustrated) therein. The ultraviolet light source is disposed above the surface of the recording medium 101 and irradiates the surface of the recording medium 101 with an active energy ray (for example, an ultraviolet ray).

The active energy ray irradiation apparatus 1 includes a blower 3 for blowing an airflow onto the surface of the recording medium 101 before being carried into the irradiator 2. An airflow is blown in order to destroy a laminar flow (air layer) containing oxygen on the surface of the recording medium 101 and to be able to replace this laminar flow with an inert gas (such as N₂). The blower 3 preferably blows an airflow onto a line-shaped area extending in a width direction orthogonal to a carry-in direction of the recording medium 101. This is for blowing the airflow over the entire surface of the recording medium 101 with a small flow volume. In addition, the blower 3 preferably ejects an airflow having directionality like a so-called air knife and having a uniform flow rate in an airflow cross section. This is for efficiently blowing the airflow onto the recording medium 101 with a small flow volume.

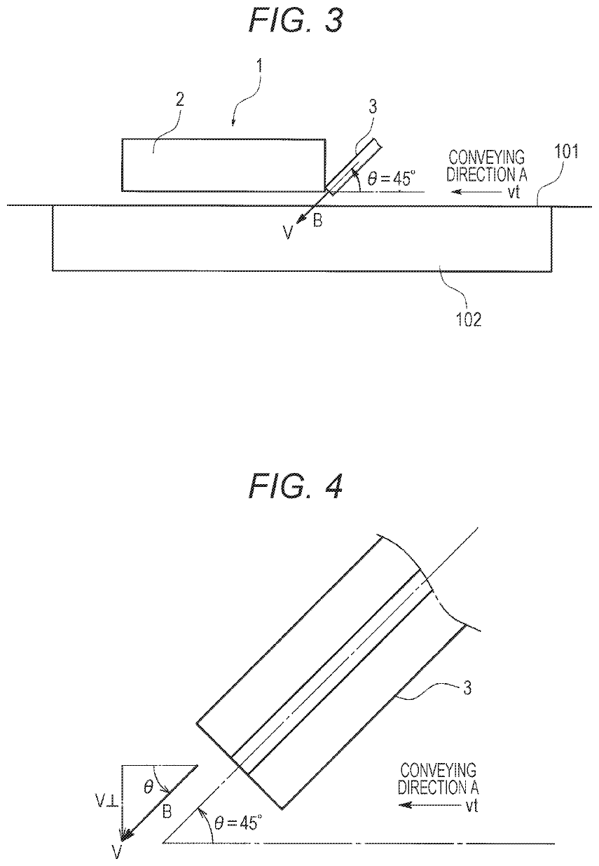

FIG. 3 is a schematic side view illustrating a mode (45°) of the active energy ray irradiation apparatus having a different airflow direction.

FIG. 4 is a schematic side view illustrating a main part of the active energy ray irradiation apparatus illustrated in FIG. 3.

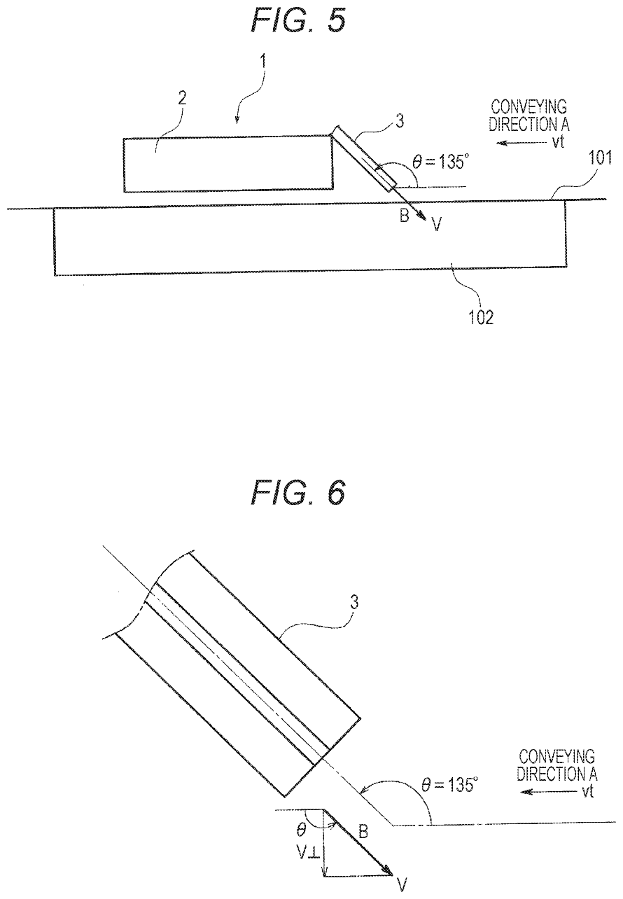

FIG. 5 is a schematic side view illustrating a mode (135°) of the active energy ray irradiation apparatus having a different airflow direction.

FIG. 6 is a schematic side view illustrating a main part of the active energy ray irradiation apparatus illustrated in FIG. 5.

In FIG. 2, a direction of a flow rate of an airflow (arrow B) from the blower 3 is set such that an angle with respect to the surface of the recording medium 101 from a front side in a carry-in direction (hereinafter referred to as “airflow angle θ”) is 90°. As illustrated in FIGS. 3 to 6, the direction of the flow rate of the airflow (arrow B) from the blower 3 can be set such that the airflow angle θ is not 90°. Incidentally, in the configuration in which the recording medium 101 is conveyed by the conveying drum, the airflow angle θ refers to an angle with respect to a tangent to the surface of the conveying drum.

On the surface of the recording medium 101, the airflow from the blower 3 has a flow rate component V⊥ in a direction perpendicular to a carry-in direction of the recording medium 101, equal to or more than 1.5 times a carry-in speed vt of the recording medium 101. When the flow rate of the airflow is represented by V, [1.5 vt≤V⊥=V·sin θ] is satisfied.

Incidentally, if the flow rate V of the airflow from the blower 3 is too large, mist may fly in a surrounding atmosphere disadvantageously.

By blowing an airflow from the blower 3 onto the recording medium 101 before being carried into the irradiator 2, the active energy ray irradiation apparatus 1 can effectively destroy a laminar flow containing oxygen on the surface of the recording medium 101. If the airflow is an airflow of an inert gas (such as N₂), the laminar flow can be replaced with the inert gas.

The inventor of the present application has found that the flow rate component V⊥ in a direction perpendicular to a carry-in direction of the recording medium 101 of the airflow from the blower 3 has a correlation with effective destruction of a laminar flow on the recording medium 101.

Even by using a radically curable ink having high reactivity with oxygen, the active energy ray irradiation apparatus 1 can destroy a laminar flow on the surface of the recording medium 101, can replace air with an inert gas, and can prevent oxygen inhibition to prevent generation of odor. Therefore, the active energy ray irradiation apparatus 1 is extremely highly useful, for example, in printing on a food package.

It has been found from the following experiment that the vertical flow rate component V⊥ of the airflow from the blower 3 can destroy the laminar flow by making the flow rate component V⊥ equal to or more than 1.5 times the carry-in speed vt of the recording medium 101. As illustrated in FIG. 2, for determining destruction of the laminar flow, first, smoke 103 was issued on an upstream side in a carry-in direction on the surface of the recording medium 101, and it was visually confirmed whether or not infiltration of the smoke 103 into a gap between the irradiator 2 and the recording medium 101 was prevented by the airflow from the blower 3. When the smoke 103 does not infiltrate a gap between the irradiator 2 and the recording medium 101 and a space above the recording medium 101 is kept transparent, it is determined that the laminar flow has been destroyed. When the laminar flow was destroyed in this manner, the airflow angle θ of the airflow from the blower 3 and the flow rate V thereof were measured. The flow rate V was measured by a flowmeter (CLIMOMASTER manufactured by KANOMAX Corporation) near the surface (1 mm from the surface) of the recording medium 101. The airflow from the blower 3 was an airflow of an inert gas (N₂).

Note that the blower 3 had an opening cross-sectional area (initial cross-sectional area of airflow) of 200 mm² at a tip thereof and a lateral width of 200 mm. A product of the opening cross-sectional area and a flow rate is a flow volume (air volume). A distance between the tip of the blower 3 and the surface of the recording medium 101 was 5 mm. This distance was kept constant even when the airflow angle θ was changed.

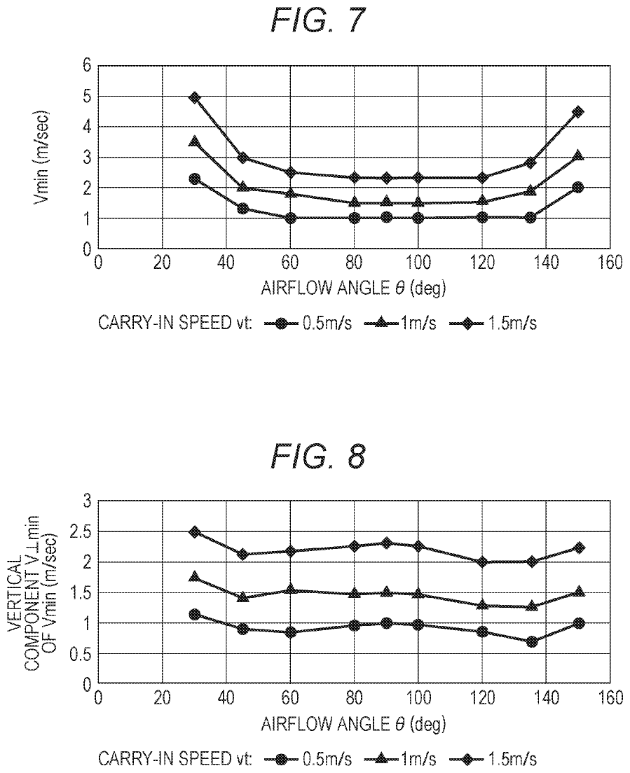

FIG. 7 is a graph illustrating a minimum condition (1) for destroying a laminar flow in the active energy ray irradiation apparatus.

As illustrated in FIG. 7, the airflow angle θ of the airflow from the blower 3 was changed (30° to 150°) by setting the carry-in speed vt of the recording medium 101 to 0.5 m/sec, 1 m/sec, or 1.5 m/sec, and it was confirmed whether or not the laminar flow was destroyed. At each carry-in speed vt and each airflow angle θ, a minimum flow rate (Vmin) at which the laminar flow was destroyed was measured. FIG. 7 illustrates the minimum flow rate Vmin at each carry-in speed vt and each airflow angle θ. FIG. 7 indicates that the minimum flow rate Vmin increases as the airflow angle θ of the airflow from the blower 3 is further away from 90°.

FIG. 8 is a graph illustrating a minimum condition (2) for destroying a laminar flow in the active energy ray irradiation apparatus.

FIG. 8 illustrates only a flow rate component V⊥min (=Vmin·sin θ) in a direction perpendicular to the carry-in direction of the recording medium 101 at the minimum flow rate Vmin obtained in FIG. 7. FIG. 8 indicates that the vertical component V⊥min of the minimum flow rate Vmin with respect to the recording medium 101 is substantially constant. Therefore, it is considered that the vertical component with respect to the recording medium 101 is effective for the airflow for destroying the laminar flow. That is, when the blower 3 is tilted with respect to the recording medium 101 (when the airflow angle θ is away from 90°), sin θ is decreased. Therefore, in order to secure the flow rate component V⊥ in the vertical direction, it is necessary to raise the flow rate V.

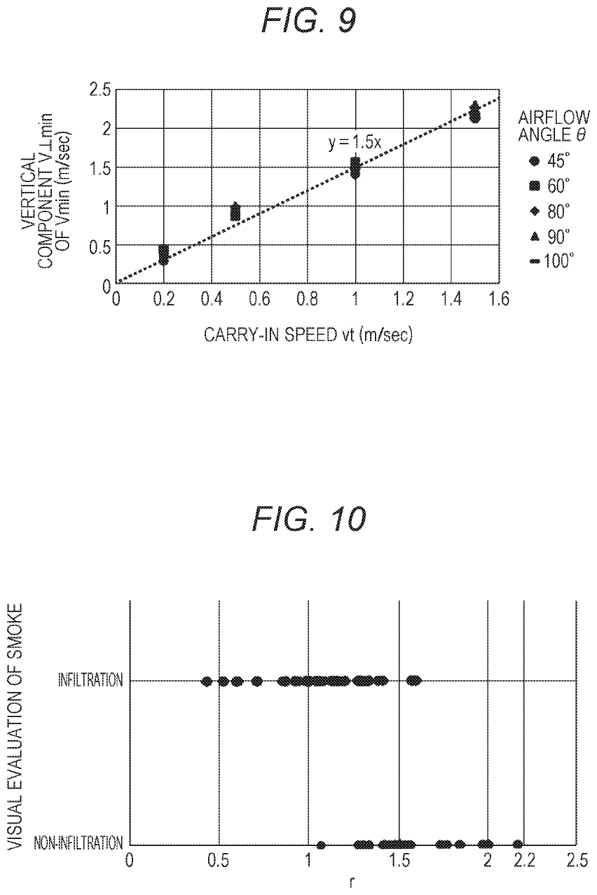

FIG. 9 is a graph illustrating a relationship between a flow rate of an inert gas in the active energy ray irradiation apparatus and a carry-in speed of a recording medium.

As illustrated in FIG. 9, regardless of the airflow angle θ, the carry-in speed vt (m/sec) of the recording medium 101 and the vertical component V⊥min (m/sec) of the minimum flow rate Vmin (m/sec) have a relationship that the vertical component V⊥min of the minimum flow rate Vmin monotonically increases with a slope of 1.5 with respect to the carry-in speed vt.

FIG. 10 is a graph illustrating a relationship between a ratio (r) of a minimum flow rate of an inert gas and a carry-in speed, and destruction of a laminar flow in the active energy ray irradiation apparatus.

As illustrated in FIG. 10, if a ratio (V⊥/vt) of the vertical component V⊥ of the flow rate V of the airflow from the blower 3 and the carry-in speed vt of the recording medium 101 is represented by r, as for each airflow angle θ (45°, 60°, 80°, 90°, 100°, 120°, or 135°) and each carry-in speed of the recording medium 101 (0.2 m/sec, 0.5 m/sec, 1 m/sec, or 1.5 m/sec), infiltration of smoke into a gap between the irradiator 2 and the recording medium 101 was prevented at r=1.5 or more, and infiltration of smoke into a gap between the irradiator 2 and the recording medium 101 could not be prevented at r=less than 1.5.

As described above, from the results illustrated in FIGS. 9 and 10, it has been found that the vertical component V⊥ of the speed V of the airflow from the blower 3 should be equal to or more than 1.5 times the carry-in speed vt of the recording medium 101. This experimental result indicates that wind speed of 1.5 times or more is required perpendicularly to the surface of the recording medium in order to block a vector (laminar flow infiltration) component along the surface of the recording medium.

Incidentally, in FIG. 8, the vertical component V⊥min of the minimum flow rate Vmin is decreased when the airflow angle θ is 100° or more because the airflow is directed in the direction opposite to the carry-in direction of the recording medium 101 to promote destruction of the laminar flow. If the blower 3 is tilted largely, for example, at the airflow angle θ=30° or 150°, the vertical component V⊥min of the minimum flow rate Vmin is slightly increased. This is because an inert gas easily flows in the horizontal direction (direction along the surface of the recording medium 101) and it is necessary to raise the flow rate V excessively in order to secure the flow rate component V⊥ in the vertical direction.

Therefore, in order to more efficiently destroy the laminar flow on the surface of the recording medium 101, the direction of the flow rate of the airflow (arrow B) from the blower 3 is preferably set such that the airflow angle θ is from 45° (as illustrated in FIGS. 3 and 4) to 135° (as illustrated in FIGS. 5 and 6).

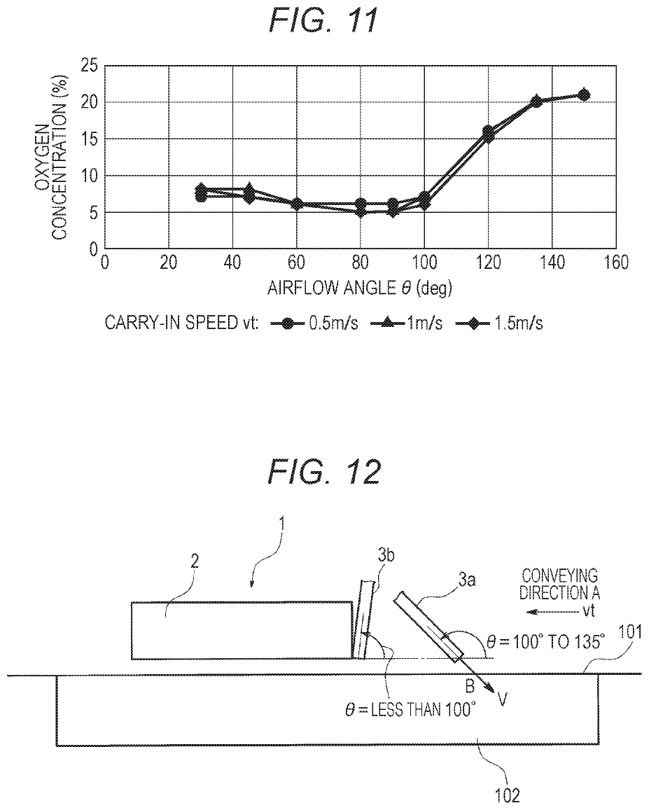

FIG. 11 is a graph illustrating an oxygen concentration when the laminar flow is destroyed in the irradiator of the active energy ray irradiation apparatus.

As illustrated in FIG. 11, when an inert gas was blown at the minimum flow rate Vmin at each airflow angle θ, an oxygen concentration between the irradiator 2 and the recording medium 101 was measured. In the measurement of the oxygen concentration, the oxygen concentration near the surface (1 mm from the surface) of the recording medium 101 was measured at a position 100 mm away downstream from the blower 3 using an oxygen meter (Microx TX3 manufactured by PreSens Precision Sensing GmbH). At the airflow angle θ=30° to 100°, the oxygen concentration is low. That is, at the airflow angle θ=30° to 100°, it is found that air is replaced with the inert gas after the laminar flow is destroyed. At the airflow angle θ=100° or more, even if the laminar flow is broken, the recording medium has no vector in the carry-in direction in which an inert gas is carried. Therefore, it is found that air is not sufficiently replaced with the inert gas.

From the above, by blowing an inert gas at the airflow angle θ of 45° to 100° and a flow rate equal to or more than the minimum flow rate Vmin, the laminar flow on the surface of the recording medium 101 could be efficiently destroyed, and air could be replaced with the inert gas. Therefore, the direction of the flow rate of the airflow from the blower 3 is more preferably set such that the airflow angle θ is from 45° to 100°.

Incidentally, in this measurement, it is determined from the measurement result of oxygen concentration that replacement with an inert gas has been made. A required oxygen concentration value can be appropriately determined according to an area filled with an inert gas, a gap between the irradiator 2 and the recording medium 101, and the like. The flow volume of the inert gas is thereby preferably optimized.

FIG. 12 is a schematic side view illustrating an active energy ray irradiation apparatus according to another embodiment of the present invention.

As illustrated in FIG. 12, an active energy ray irradiation apparatus 1 may include a first blower 3a for blowing an airflow onto a surface of a recording medium 101 before being carried into an irradiator 2, and a second blower 3b for supplying an inert gas onto the surface of the recording medium 101 onto which the airflow has been blown by the first blower 3a.

The airflow ejected from the first blower 3a is not an inert gas, but may be an inert gas.

The first blower 3a preferably blows an airflow onto a line-shaped area extending in a width direction orthogonal to a carry-in direction of the recording medium 101. This is for blowing the airflow over the entire surface of the recording medium 101 with a small flow volume. In addition, the first blower 3a preferably ejects an airflow having directionality like a so-called air knife and having a uniform flow rate in an airflow cross section. This is for efficiently blowing the airflow onto the recording medium 101 with a small flow volume.

On the surface of the recording medium 101, the airflow from the first blower 3a has a flow rate component V⊥ in a direction perpendicular to a carry-in direction of the recording medium 101, equal to or more than 1.5 times a carry-in speed vt of the recording medium 101.

In the active energy ray irradiation apparatus 1, a laminar flow on the surface of the recording medium 101 is destroyed by the airflow from the first blower 3a, and then an inert gas is supplied onto the surface of the recording medium 101 where the laminar flow has been destroyed by the second blower 3b.

The laminar flow is destroyed by the airflow from the first blower 3a. Therefore, even if the airflow from the first blower 3a is not an inert gas, the second blower 3b can replace air on the surface of the recording medium 101 with an inert gas without blowing an airflow at such a high flow rate as in the case where only the single blower 3 is disposed. This makes it possible to reduce the amount of required inert gas.

Note that a direction of a flow rate of an airflow (arrow B) from the first blower 3a is preferably set such that an angle with respect to the surface of the recording medium 101 from a front side in a carry-in direction (airflow angle θ) is from 100° to 135°. In order to carry an inert gas on the recording medium 101, the second blower 3b is preferably set such that an angle with respect to the surface of the recording medium 101 from a front side in a carry-in direction (airflow angle θ) is less than 100°.

Although embodiments of the present invention have been described and illustrated in detail, the disclosed embodiments are made for purposes of illustration and example only and not limitation, and various modifications and design changes may be made without departing from the gist of the present invention. It goes without saying that specific detailed structures, numerical values, and the like can be changed appropriately. In addition, it should be considered that the embodiments disclosed here are illustrative in all respects and not restrictive. The scope of the present invention should be interpreted by terms of the appended claims, and intends to include all modifications within meaning and scope equivalent to the claims.

What is claimed is:

1. An active energy ray irradiation apparatus comprising:
an irradiator into which a recording medium having a surface to which a radically curable ink to be cured by an active energy ray is attached is carried in a direction along the surface and which irradiates the radically curable ink with an active energy ray; and
a blower that blows an airflow onto the surface of the recording medium before being carried into the irradiator, wherein
the airflow has a flow rate component in a direction perpendicular to a carry-in direction of the recording medium, equal to or more than 1.5 times a carry-in speed of the recording medium, on the surface of the recording medium.

2. The active energy ray irradiation apparatus according to claim 1, wherein a direction of a flow rate of the airflow is set such that an angle with respect to the surface of the recording medium from a front side in a carry-in direction is from 45° to 135°.

3. The active energy ray irradiation apparatus according to claim 1, wherein a direction of a flow rate of the airflow is set such that an angle with respect to the surface of the recording medium from a front side in a carry-in direction is from 45° to 100°.

4. The active energy ray irradiation apparatus according to claim 1, wherein the blower blows an airflow onto a line-shaped area extending in a width direction orthogonal to a carry-in direction of the recording medium.

5. The active energy ray irradiation apparatus according to claim 1, wherein the blower ejects an airflow having directionality and a uniform flow rate in an airflow cross section.

6. The active energy ray irradiation apparatus according to claim 1, wherein the blower ejects an airflow of an inert gas.

7. An active energy ray irradiation apparatus comprising:
an irradiator into which a recording medium having a surface to which a radically curable ink is attached is carried in a direction along the surface and which irradiates the radically curable ink with an active energy ray;
a first blower that blows an airflow onto a surface of the recording medium before being carried into the irradiator; and
a second blower that supplies an inert gas onto the surface of the recording medium onto which the airflow has been blown by the first blower, wherein
the airflow from the first blower has a flow rate component in a direction perpendicular to a carry-in direction of the recording medium, equal to or more than 1.5 times a carry-in speed of the recording medium, on the surface of the recording medium.

8. The active energy ray irradiation apparatus according to claim 7, wherein a direction of a flow rate of the airflow from the first blower is set such that an angle with respect to the surface of the recording medium from a front side in a carry-in direction is from 100° to 135°.

9. The active energy ray irradiation apparatus according to claim 7, wherein the first blower blows an airflow onto a line-shaped area extending in a width direction orthogonal to a carry-in direction of the recording medium.

10. The active energy ray irradiation apparatus according to claim 7, wherein the first blower ejects an airflow having directionality and a uniform flow rate in an airflow cross section.

11. An inkjet printer comprising:
a conveyer that conveys a recording medium;
a recording head that attaches a radically curable ink to the recording medium conveyed by the conveyer; and
the active energy ray irradiation apparatus according to claim 1.
